(19) United States
(12) Patent Application Publication
(10) Pub. No.: US 2007/0085540 A1
(43) Pub. Date: Apr. 19, 2007

(54) Method for developing a transmit coil of a magnetic resonance system

(76) Inventors: Jian Jun Du, Shenzhen (CN); Jian Min Wang, Shenzhen (CN)

Correspondence Address: SCHIFF HARDIN, LLP;PATENT DEPARTMENT, 6600 SEARS TOWER, CHICAGO, IL, 60606-6473, US

(21) Appl. No.: 11/540,123

(22) Filed: Sep. 29, 2006

(30) Foreign Application Priority Data
Sep. 30, 2005 (CN) 200510107798.0

(51) Int. Cl. G01V 3/00

(52) U.S. Cl. 324/311; 324/322; 324/318

(57) ABSTRACT

In a method for decoupling an RF transmit coil in a magnetic resonance imaging system, the RF transmit coil has more than one antenna unit and stimulus signals are inputted to said antenna units via connecting cables. A capacitor is connected in series before each of the cables and the value of the series capacitor is such that it just compensates the signal phase shift caused by the connecting cable to zero. Decoupling circuits are connected between said antenna units and before the series capacitors for decoupling said antenna units. The decoupling circuit, by simply employing the decoupling capacitor, decouples the inductive coupling and capacitive coupling between the antenna units simultaneously. The method can be employed to decouple an RF transmit coil outside a magnetic body via the use of a decoupling capacitor.

### BACKGROUND OF THE INVENTION

1. Field of the Invention

The present invention relates to a method for decoupling an antenna array of an RF transmit coil, and more particularly, to a method for decoupling an RF transmit coil which decouples an antenna array of an RF transmit coil in a Magnetic Resonance Imaging (MRI) system, outside the RF transmit coil.

2. Description of the Prior Art

An RF transmit coil is an important part of a Magnetic Resonance Imaging (MRI) system, which is used for producing variable pulse sequences so as to stimulate the hydrogen atomic nucleus in a human body to generate magnetic resonance signals.

The RF transmit coil includes an antenna array, and the antenna array includes several antenna units which are fitted in the magnetic body of the MRI system.

In the prior art, there are mainly two methods for detuning the RF transmit coil, one is adding detuned circuits within the antenna units, but this method would decrease the quality factor (also called Q factor) and emission efficiency of the antenna units, at the same time also increase the complication of the antenna units, and thus the application range of this method is relatively limited; the other is connecting with detuned circuits outside the RF transmit coil via a cable to realize detuning, however, in this case, the length of the cable is required to be integer multiples of half-wavelength (λ/2), thus the short-circuit condition of the detuned circuit can be inputted to the antenna units. This requirement of using the half-wavelength cable brings a very serious drawback to the structure and performance of the RF transit coil: a certain amount of consumption will occur when the current from the resonance circuit consisting of the half-wavelength cable and the circuits inside and outside the antenna unit passes through the cable, and this consumption will decrease the emission efficiency of the antenna units; especially when the operating wavelength of the RF transmit coil is relatively long, or when it is applied to a low field system, the half-wavelength cable will be relatively long, which makes said consumption more significant.

Therefore, there is a need in this field to provide an RF transmit coil structure which employs a detuning circuit outside the RF transmit coil for detuning and enables the length of the connecting cable to be as short as possible.

Referring to FIG. 1, a known antenna array of the RF transmit coil comprises four antenna units, i.e. antenna unit 1, antenna unit 1, antenna unit 3 and antenna unit 4. Certainly, a similar antenna array also can have fewer or more than four antenna units. Herein, the drawbacks and the problems to be solved in the structure of the RF transmit coil and the decoupling method in the prior art are explained with reference to the structure having four antenna units. The corresponding four power input channels in the MRI system carry the orthogonal stimulus signals into said antenna units 1 to 4 as per phase differences 0°, 90°, 180° and 270°.

In order to obtain the orthogonal stimulus signals inputted according to 0°, 90°, 180° and 270° phase differences, the signal input feeding points of 0° and 90° divided from a power divider can be moved to the positions with 180° phase difference (phase difference is equivalent to adding a half-wavelength cable). As shown in FIG. 1, the 0° signal divided from the power divider passes through a full-wavelength and half-wavelength cable respectively, thus signals with 0° and 180° phase difference are acquired respectively to be carried into the antenna units; in like manner, the 90° signal divided from the power divider passes through a full-wavelength and half-wavelength cable respectively, thus signals with 90° and 270° phase difference are acquired respectively to be carried into the antenna units, and thus the required orthogonal stimulus is obtained using the method. Another method is shown in FIG. 2. The 0° signal divided from a power divider respectively passes through an inverter I1 first and then a half-wavelength cable and directly passes through a half-wavelength cable, thus signals with 0° and 180° phase difference are acquired respectively to be carried into the antenna units; in like manner, the 90° signal divided from the power divider respectively passes through an inverter I2 first and then a half-wavelength cable and directly passes through a half-wavelength cable, thus signals with 90° and 270° phase difference are acquired respectively to be carried into the antenna units, and thus the required orthogonal stimulus can also be obtained using said method.

Since couplings tend to occur during the operation among each of the antenna units, these couplings will seriously affect the normal work of the antenna units and the RF transmit coil, and decrease the operating efficiency of the RF transmit coil, especially when the RF transmit coil operates at high power and high voltage, the coupling will be more critical. In the prior art, the method for decoupling the antenna units is to add decoupling capacitors or inductors among the coil units, whereas the kind, number and value of required elements for decoupling will vary with the operating frequency of the RF transmit coil. Therefore, how to implement the decoupling for the RF transmit coil within a wide frequency band is of significance for the normal operation of the RF transmit coil.

The known decoupling method within a wide frequency band is primarily to adjust the RF transmit coil at a centre frequency, and meet the technical requirements of the RF transmit coil for the antenna units within a certain bandwidth. In addition, when the antenna units operate at the edge of said bandwidth, the decoupling will deteriorate obviously. In this case, the antenna units sometimes cannot even work normally.

At present there are two methods for solving these problems: one is using different antenna units that operate in different bandwidths and adjusting the centre frequency of said different antenna units respectively, although using this method means that different antenna units need to be used for different bandwidths, and these antenna units cannot be interchangeable, which not only increases the complication of the manufacture and maintenance of the RF transmit coil, but also increases the cost greatly; the other method is using a variable capacitor or inductor connected between the corresponding antenna units to decouple directly, thus achieving decoupling of the whole operating bandwidth. Since the antenna units of the RF transmit coil operate under high power and high voltage, the decoupling capacitors are required to have high-voltage tolerance, whereas it is hard to make the value of the capacitors very high, and it is also very expensive; if inductors are used for the decoupling, huge-volume inductors are needed to meet the requirements; in practical application, several variable capacitors or inductors are often needed to meet the decoupling requirements, which increases the cost greatly. Moreover, the inner space of the MRI system is very limited and valuable, but said decoupling capacitors or inductors are fitted between the antenna units, and their huge volume occupies a mass of magnetic space. It is very inconvenient to adjust or replace the decoupling capacitor or inductor in the magnetic limited inner space and intense magnetic field, and the operation of the adjustment and replacement is very complicated which needs professionals and technical equipment.

From the circuit point of view, the principle of the decoupling is using reactive elements to compensate the coupling among the antenna units, that is, using the capacitors to compensate the inductive coupling and using the inductors to compensate the capacitive coupling. The principle of the methods for decoupling the RF transmit coil in the prior art is shown in FIGS. 1 and 2. Taking FIG. 2 as an example, the section of the stimulus signals input and the detuned circuit outside the RF transmit coil is shown to the left of the broken line, which can be arranged outside the magnetic body via a half-wavelength cable; the section of antenna units and the decoupling parts of the RF transmit coil is shown to the right of the broken line, which is arranged within the magnetic body. In FIG. 2 the inductive couplings M₁₂, M₂₃, M₃₄, M₁₃, M₂₄ and M₁₄ occur between said antenna units 1 to 4, and the decoupling capacitors C₁₃, C₂₃, C₂₄ and C₁₄ are connected between the corresponding antenna units, which is taken as an example to explain the drawbacks of the method for decoupling the RF transmit coil in the prior art. M₁₂ and M₃₄ operate in the same line, and their field intensity can be cancelled out through adding the other, so it is not necessary to consider the decoupling compensation for M₁₂ and M₃₄. In the case that the inductive couplings occur between said antenna units 1 to 4, it is necessary to connect the decoupling inductors between the corresponding antenna units to compensate. This decoupling method for the RF transmit coil in the prior art has the following drawbacks: the decoupling capacitors or inductors are connected directly between the corresponding antenna units, that is, the decoupling is within the magnetic body, therefore, the antenna units cannot be made into standard parts, which need to use different values of the decoupling capacitors or inductors according to different operating frequencies, and need to adjust said decoupling capacitors or inductors within the magnetic limited space during installation. Moreover, in the case of the inductive coupling occurring between the antenna units 1 to 4, in the prior art the solution is to connect the decoupling inductors between the corresponding antenna units to compensate, but compared with the decoupling capacitors, the quality factor of the decoupling inductors is smaller than that of the decoupling capacitors and consumption tends to occur, and the volume of decoupling inductors is much larger, which needs more valuable magnetic limited space.

### SUMMARY OF THE INVENTION

An object of the present invention is to propose a method for decoupling an RF transmit coil outside a magnetic body.

A further object of the present invention is to propose a method for decoupling an RF transmit coil which decouples an inductive coupling and capacitive coupling of the RF transmit coil simultaneously by using a decoupling capacitor.

Another object of the present invention is to propose a method for decoupling an RF transmit coil, so that the cable connecting the RF transmit coil and the decoupling circuit can be shortened, and thus the energy consumption in the cable is decreased.

Another object of the present invention is to propose a method for decoupling an RF transmit coil, so as to provide a kind of universal antenna unit independent of the decoupling circuits.

To achieve the above objects, the present invention proposes a method for decoupling an RF transmit coil, the RF transmit coil comprising more than one antenna unit, stimulus signals being inputted to said antenna units via connecting cables, wherein a capacitor is connected in series before each of the cables, the value of the series capacitor is such that it just compensates the signal phase shift caused by the connecting cable to zero, and the decoupling circuits are connected between the antenna units and before the series capacitors for decoupling the antenna units.

The stimulus signals are explained in the present invention taking orthogonal stimulus signals as an example. The orthogonal stimulus signals are divided from a power divider, and each orthogonal stimulus signal is connected with said series capacitor directly and through an inverter, for respectively inputting the orthogonal stimulus signals to the antenna units.

The decoupling circuits use the decoupling capacitors as decoupling members to simultaneously decouple the inductive coupling and the capacitive coupling of the antenna units, and two ends of the decoupling capacitor are connected between the antenna units having the orthogonal signals inputted thereto, with the connected ends being arranged before the associated series capacitor for the connecting cables; in the case that the inverter is connected before the series capacitor, the connected ends of the decoupling capacitor are arranged between the series capacitor and the inverter.

Moreover, in the present invention the two ends of the decoupling capacitor having both ends arranged between the series capacitor and the inverter are simultaneously moved before the inverter and combined with the decoupling capacitor whose two ends are also connected before the inverter, and the two ends of the combined decoupling capacitor are connected before the inverter.

Adding the series capacitor before the cable can make it possible to decouple before the series capacitor instead of as is originally the case, between antenna units i.e. within the MRI magnetic body, and realize decoupling outside the magnetic body. Since the present invention, by simply using the decoupling capacitor, can decouple the inductive and capacitive couplings of the RF transmit coil simultaneously, it ensures a high quality factor and emission efficiency of the RF transmit coil. Similarly, since the series capacitor compensates the phase shift resulting from the connecting cable to zero, the connecting cables do not have to be limited to half-wavelength, but can be shortened according to the practical situation, thus the energy consumption in the cable will be reduced. Since the decoupling circuit of the RF transmit coil is moved outside the magnetic body, it does not need to install the decoupling elements which require different values based on practical conditions and professionals to adjust between the antenna units, and hence the antenna units can be designed as mutually exchangeable standard parts, so that the cost of the manufacture and maintenance for the RF transmit coil can be reduced.

### BRIEF DESCRIPTION OF THE DRAWINGS

FIG. 1 is a schematic diagram of an embodiment of a method for decoupling an RF transmit coil in the prior art.

FIG. 2 is a schematic diagram of another embodiment of a method for decoupling an RF transmit coil in the prior art.

FIG. 3 is a schematic diagram illustrating the shortening of an RF transmit coil and the cable of its outer circuit using a method for decoupling the RF transmit coil in accordance with the present invention.

FIG. 4 is a schematic plan of an equivalent circuit using a decoupling principle for a decoupling method of an RF transmit coil in accordance with the present invention.

FIGS. 5 to 10 are schematic diagrams for realizing a decoupling method of an RF transmit coil in the present invention in the case of an inductive coupling.

FIGS. 11 to 14 are schematic diagrams for realizing a decoupling method of an RF transmit coil in the present invention in the case of a capacitive coupling.

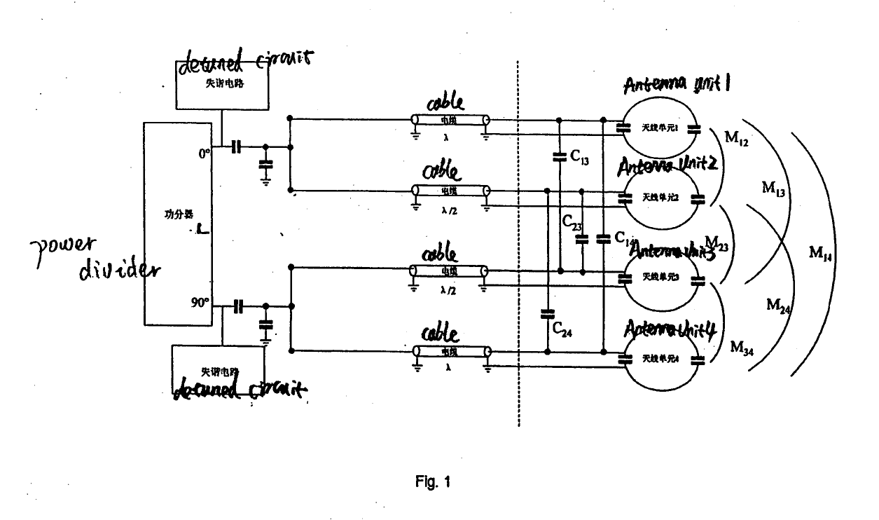

### DESCRIPTION OF THE PREFERRED EMBODIMENTS

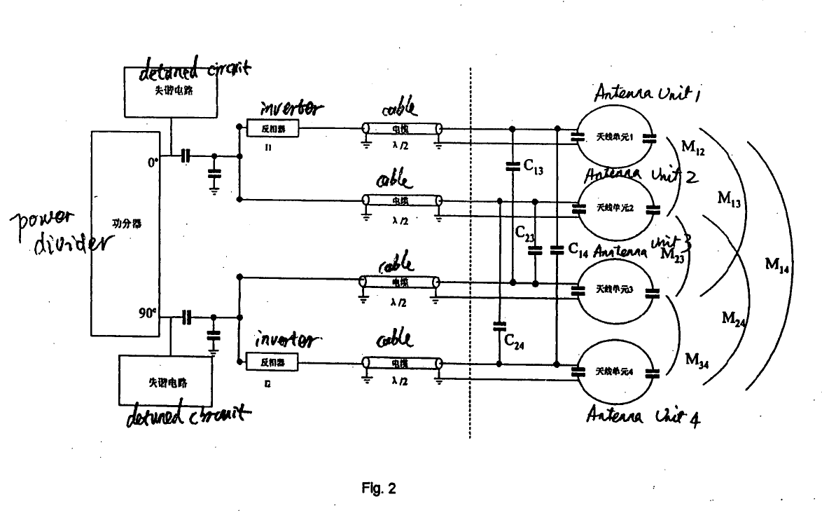

Referring to FIG. 2, the section of stimulus signals input and detuned circuit outside an RF transmit coil in the prior art is shown to the left of the broken line, and the section of the RF transmit coil and decoupling parts of the RF transmit coil in the prior art is shown to the right of the broken line. In this embodiment, it is taken as an example that the RF transmit coil has four antenna units i.e. antenna units 1 to 4 as shown in FIG. 2. The detuned circuit and the orthogonal stimulus signals are respectively connected with the antenna units 1 to 4 via a half-wavelength cable. Within this, a 0° signal and 90° signal are divided from a power divider, and the 0° signal passes through a half-wavelength cable directly and passes through an inverter I1 first and then a half-wavelength cable respectively to carry 0° and 180° signals into the antenna units; the 90° signal passes through a half-wavelength cable directly and passes through an inverter 12 first and then a half-wavelength cable respectively to carry 90° and 270° signals into the antenna units. In this embodiment, the inductive couplings M₁₂, M₂₃, M₃₄, M₁₃, M₂₄ and M₁₄ occur between said antenna units 1 to 4, and the decoupling capacitors C₁₃, C₂₃, C₂₄ and C₁₄ are connected between the corresponding antenna units, which is used as an example for explanation.

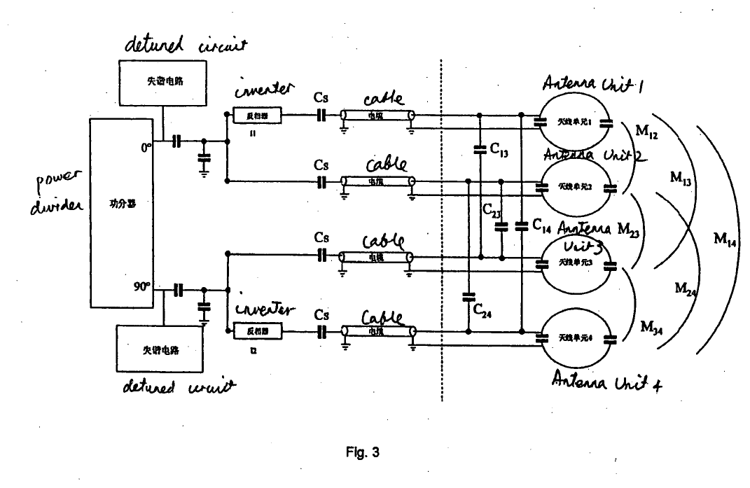

Referring to FIG. 3, in order to shorten said half-wavelength cable, a capacitor Cs is connected in series before the cable, and the value of the capacitor Cs can compensate the signal phase shift caused by the cable to zero, and here the length of the cable can be arbitrary, and not limited to a half wavelength as in the prior art. Therefore, the cable connecting the antenna units 1 to 4 and the cable of the outer circuit of the RF transmit coil can be shortened as much as possible to reduce the signals' energy consumption.

Since the capacitor Cs connected with the cable compensates the phase shift caused by the cable to zero, the decoupling capacitor connected between the antenna units, as shown to the right of the broken line in the Figure, can be moved before said series capacitor Cs of the cable.

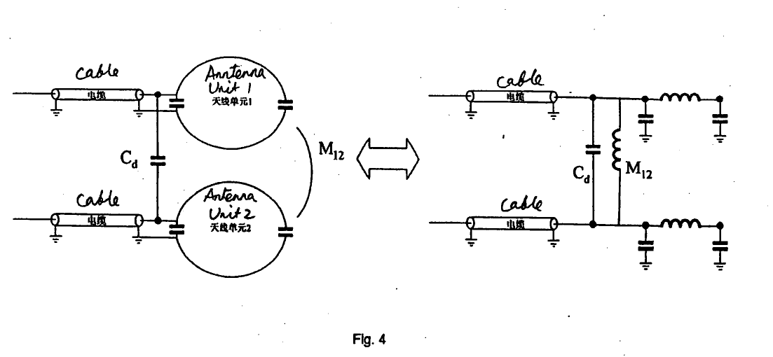

Referring to FIG. 4, the decoupling principle applied by the present invention is shown. As shown in the left part of FIG. 4, suppose the inductive coupling M₁₂ occurs between the antenna unit 1 and 2, so the decoupling capacitor C_{d} is connected between the antenna units 1 and 2 for decoupling, whose equivalent circuit is shown in the right part of FIG. 4: suppose the operating angular frequency of the RF transmit coil is ω, the decoupling capacitance is C_{d}, and the inductor is M₁₂, then the decoupling should satisfy the following condition:

$$\frac{j}{ω {C}_{d}} = jω {M}_{12} .$$

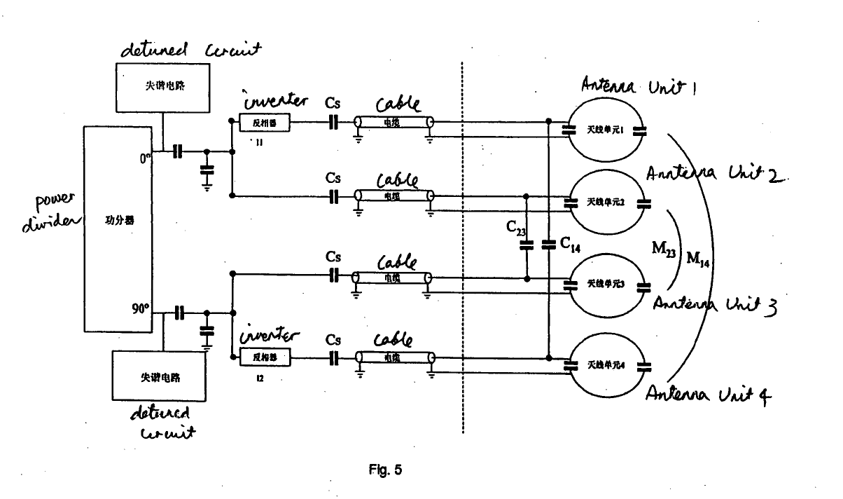

FIGS. 5 to 10 illustrate step by step how to move the decoupling between the antenna units 1 to 4 before the series capacitor Cs of the cable in the case of the inductive coupling by using the method of the present invention.

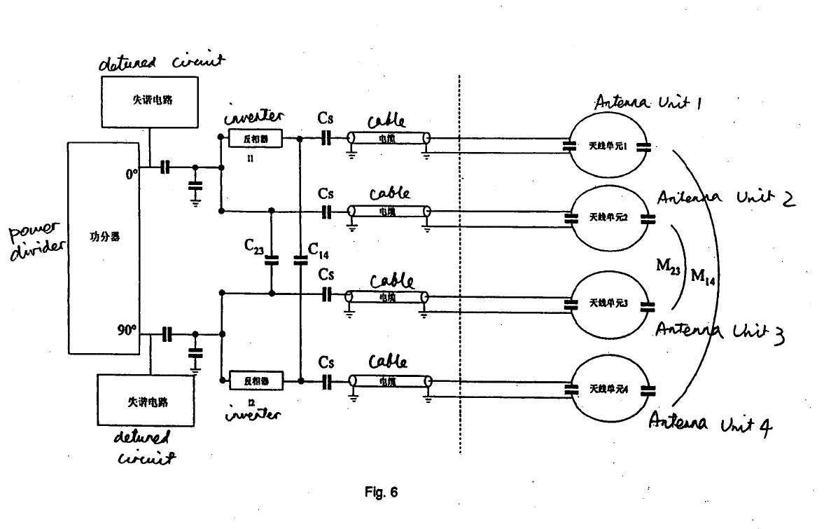

Referring to FIG. 5, in order to decouple the inductive coupling M₂₃ between the antenna units 2 and 3 and the inductive coupling M₁₄ between the antenna units 1 and 4, the prior art decouples directly by connecting the decoupling capacitors C₂₃ between the antenna units 2 and 3 and connecting C₁₄ between the antenna units 1 and 4, respectively. However, as noted above, since the capacitor Cs compensates the phase shift resulting from the cable to zero, C₂₃ and C₁₄ can be moved equivalently before the series capacitor Cs respectively as shown in FIG. 6; wherein, C₂₃ is connected before the series capacitor Cs connected with the antenna units 2 and 3, and C₁₄ is connected between the inverters I1, I2 connected with the antenna unit 1 and 4 and their associated series capacitor Cs.

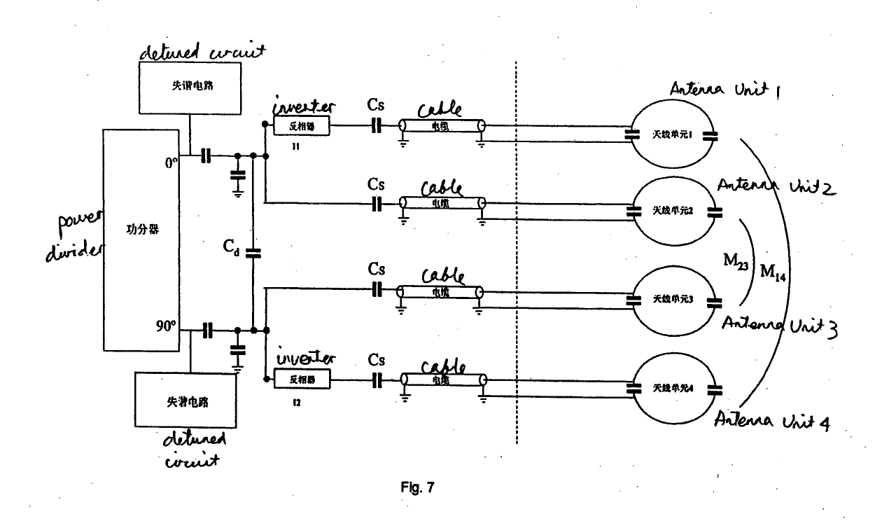

Referring to FIG. 6, the stimulus signals from the antenna units 1 and 4 both pass through the inverters I1 and I2 first and then reach two ends of C₁₄, therefore, the two ends of the decoupling capacitor C₁₄ can be moved simultaneously before the inverter I1 and I2 as shown in FIG. 7, and combined with the decoupling capacitor C₂₃ whose two ends are also thought to be connected before said inverters into the decoupling capacitor C_{d} whose two ends are connected before the inverters I1 and I2.

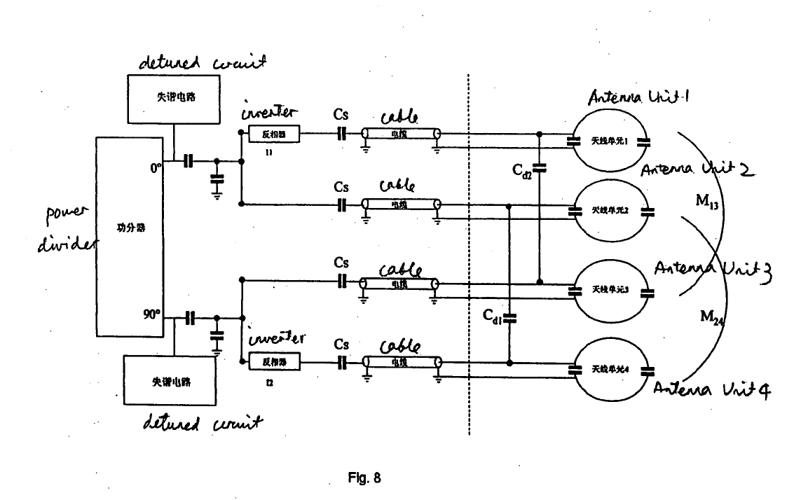

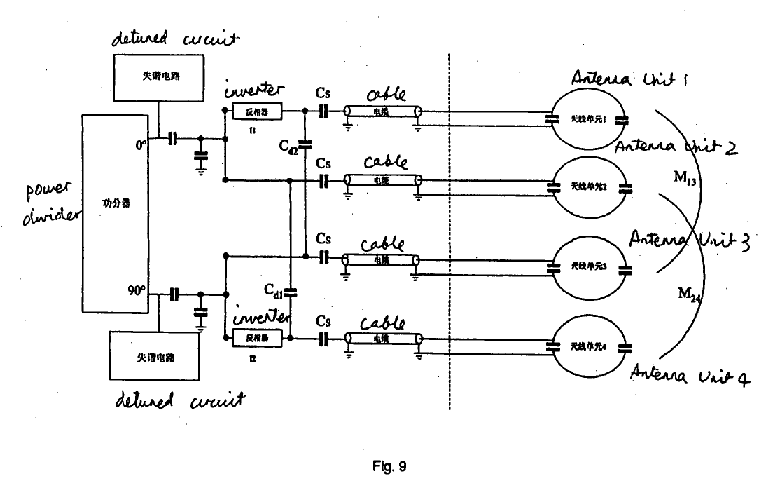

Referring to FIG. 8, in order to decouple the inductive coupling M₂₄ between the antenna units 2 and 4 and the inductive coupling M₁₃ between the antenna units 1 and 3, the prior art decouples directly via connecting the decoupling capacitor C_{d}, between the antenna units 2 and 4 and connecting C_{d2} between the antenna units 1 and 3 respectively. However, as noted above, since the capacitor Cs compensates the phase shift resulted from the cable to zero, C_{d1} and C_{d2} can be moved equivalently before the series capacitor Cs respectively as shown in FIG. 9; wherein one end of C_{d1} is connected before the series capacitor Cs connected with the antenna unit 2, and the other end is connected between the inverter I2 connected with the antenna unit 4 and the capacitor Cs, and one end of C_{d2} is connected between the inverter I1 connected with the antenna unit 1 and the capacitor Cs, and the other end is connected before the series capacitor Cs connected with the antenna unit 3.

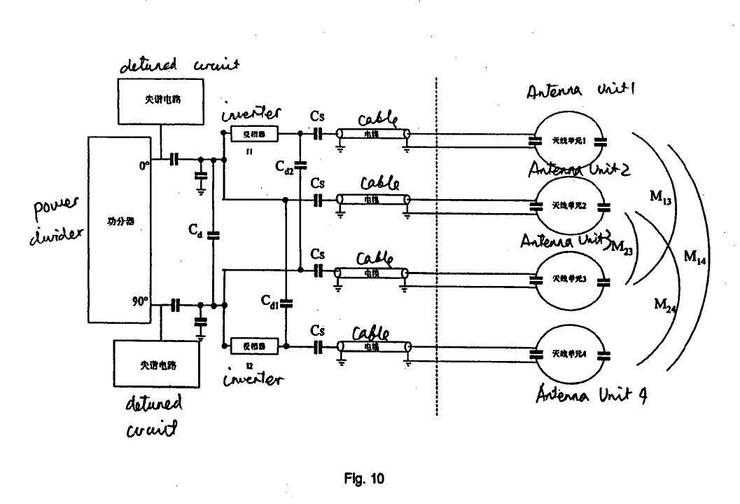

Referring to FIG. 10, as described above, the inductive couplings occur between the antenna units to which the orthogonal stimulus signals are inputted, such as the couplings M₁₃ and M₁₄ between the antenna units 1 and 3 or 4 respectively, and the couplings M₂₃ and M₂₄ between the antenna units 2 and 3 or 4 respectively, and the decoupling capacitors C_{d}, C_{d1}, and C_{d2} connected before the series capacitor Cs of the cable of the corresponding antenna units and the inverters I1, I2 can be used to decouple said inductive coupling; wherein the capacitor C_{d} is formed by combining C₂₃ and C₂₄ in FIG. 6. Since the inductive coupling M₁₂ between the antenna units 1 and 2 and M₃₄ between the antenna units 3 and 4 are in the same direction, their field intensities can be added, so there is no need to consider the decoupling compensation for M₁₂ and M₃₄.

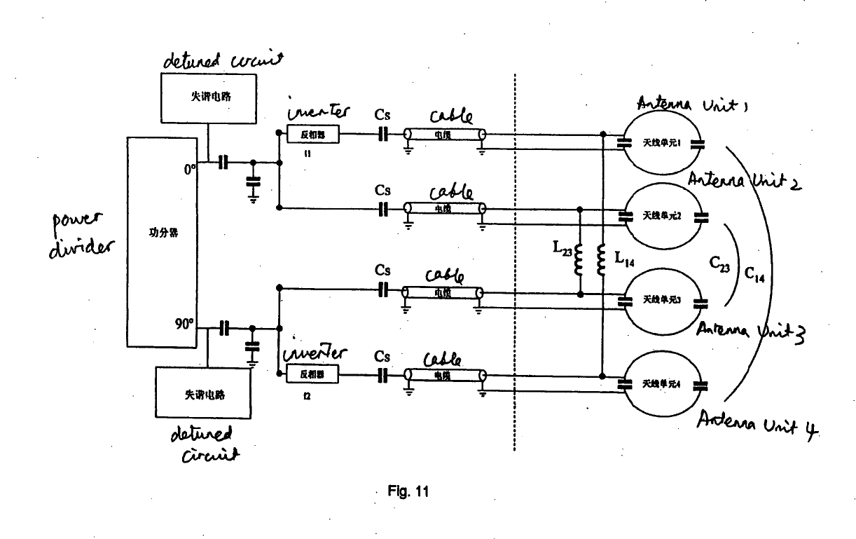

The above description illustrates how the present invention uses the decoupling capacitor to move the decoupling between the antenna units 1 to 4 before the series capacitor Cs of the cable in the case that the inductive couplings occur between said antenna units 1 to 4, and FIGS. 11 to 14 illustrate how the present invention uses the decoupling capacitor in the same way to move the decoupling between the antenna units 1 to 4 before the series capacitor Cs of the cable in the case that the capacitive couplings occur between the antenna units 1 to 4.

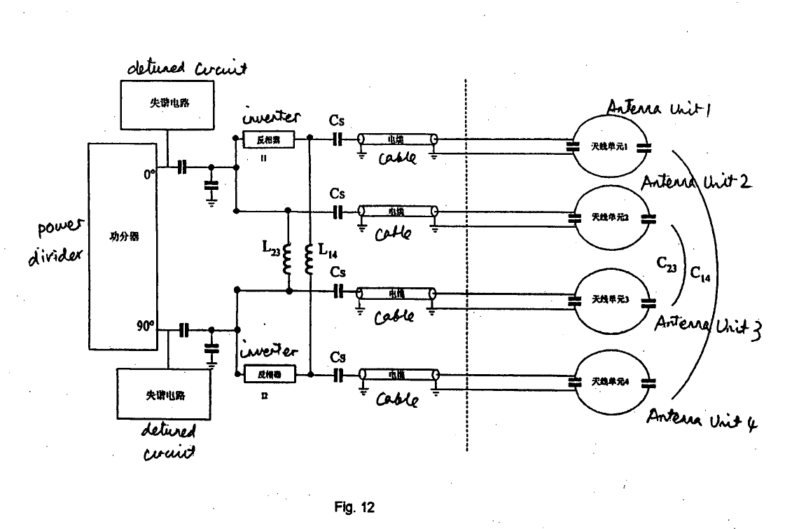

Referring to FIG. 11, in order to decouple the capacitive coupling C₁₄ between the antenna units 1 and 4 and the capacitive coupling C₂₃ between the antenna units 2 and 3, the prior art decouples directly via connecting the decoupling inductor L₁₄ between the antenna units 1 and 4 and connecting L₂₃ between the antenna units 2 and 3 respectively. However, as said above, since the capacitor Cs compensates the phase shift resulted from the cable to zero, L₁₄ and L₂₃ can be moved equivalently before the capacitor Cs respectively, wherein L₂₃ is connected before the capacitor Cs connected with the antenna units 2 and 3, and L₁₄ is connected between the inverters I1, I2 connected with the antenna units 1 and 4 and the capacitor Cs, as shown in FIG. 12. The present invention is characterized in that the compensation of the inductor for the inductive coupling between the antenna units can be converted into the compensation of the decoupling capacitor for the capacitive coupling between the antenna units: in accordance with the decoupling principle shown in FIG. 4, suppose the operating angular frequency to be ω, the capacitive coupling C_{d}, and the inductor L_{d}, according to the decoupling condition:

$$\frac{j}{ω {C}_{d}} = jω {M}_{12} ,$$

and

it can be deduced that:

$$\frac{1}{jω {C}_{d}} = - jω {L}_{d} .$$

Therefore, the compensation of the decoupling inductor L₁₄ connected between the inverters I1, I2 connected with the antenna units 1 and 4 and the capacitor Cs for the capacitive coupling C₁₄ is equivalent to the compensation of the decoupling inductor C_{d1} for the capacitive coupling C₁₄ as shown in FIG. 9, and one end of C_{d1} is connected before the series capacitor Cs connected with the antenna unit 2, and the other end is connected between the inverter I2 connected with the antenna unit 4 and the capacitor Cs. In the same manner, the compensation of the decoupling inductor L₂₃ connected before the capacitor Cs connected with the antenna units 2 and 3 for the capacitive coupling C₂₃ is equivalent to the compensation of the decoupling inductor C_{d2} for the inductive coupling C₂₃ as shown in FIG. 9, and one end of C_{d1} is connected before the series capacitor Cs connected with the antenna unit 3, and the other end is connected between the inverter I1 connected with the antenna unit 1 and the capacitor Cs.

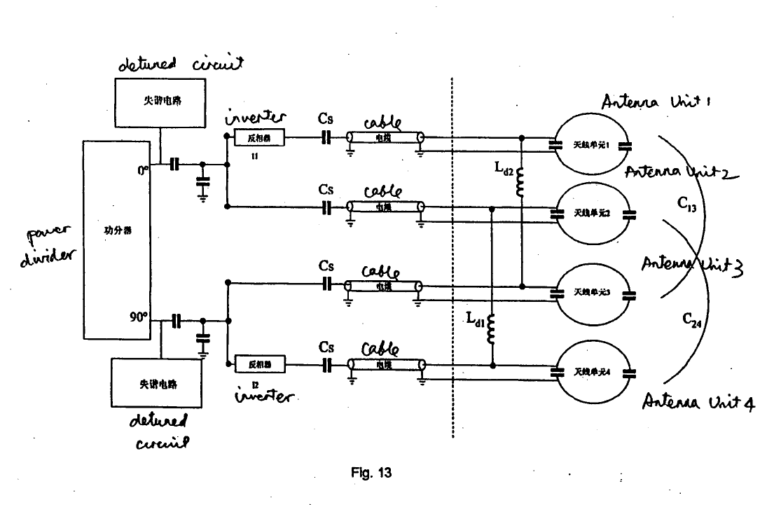

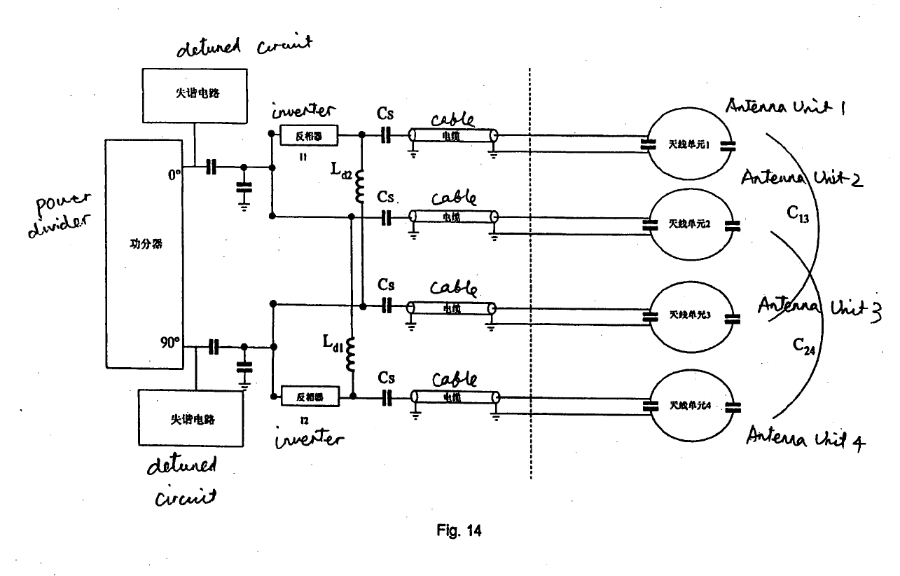

Referring to FIG. 13, in order to decouple the capacitive coupling C₁₃ between the antenna units 1 and 3 and the capacitive coupling C₂₄ between the antenna units 2 and 4, the prior art decouples directly via connecting the decoupling inductor L_{d1} between the antenna units 2 and 4 and connecting L_{d2} between the antenna units 1 and 3 respectively. However, as said above, since the capacitor Cs compensates the phase shift resulted from the cable to zero, L_{d1} and L_{d2} can be moved equivalently before the capacitor Cs respectively; wherein one end of L_{d1} is connected before the capacitor Cs connected with the antenna unit 2, and the other end is connected between the inverter I2 connected with the antenna unit 4 and the capacitor Cs; and one end of L_{d2} is connected before the capacitor Cs connected with the antenna unit 3, and the other end is connected between the inverter I1 connected with the antenna unit 1 and the capacitor Cs, as shown in FIG. 14. In said same manner, said compensation of L_{d1} for the capacitive coupling C₂₄ is equivalent to the compensation of the decoupling capacitor C₁₄ for the capacitive coupling C₁₃ as shown in FIG. 6; said compensation of L_{d2} for the capacitive coupling C₁₃ is equivalent to the compensation of the decoupling capacitor C₂₃ for the capacitive coupling C₁₃ as shown in FIG. 6. Furthermore, as described above, the decoupling capacitors C₁₄ and C₂₃ as shown in FIG. 6 can be combined into the decoupling capacitor C_{d} as shown in FIG. 7.

In summary, whether inductive coupling or capacitive coupling occurs between the antenna units 1 to 4, both can be decoupled accordingly using the decoupling capacitors C_{d}, C_{d1} and C_{d2} as shown in FIG. 10; at the same time, the cable and the series capacitor Cs before the cable can make it possible to decouple the couplings between the antenna units 1 to 4 outside the MRI magnetic body instead of, as is originally the case, between the antenna units i.e. within the MRI magnetic body. Similarly, adding the capacitor Cs makes the cable not be limited to a half-wavelength, thus the cable can be shortened as much as possible according to the practical situation to reduce the energy consumption. Moreover, since there are no decoupling capacitors and inductors whose values need to be confirmed according to different MRI systems and be adjusted when installing connections between said antenna units, these antenna units can be designed as convenient changeable standard parts, and said antenna units only need to be adjusted at the centre frequency during manufacture.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for decoupling an RF transmit coil, the RF transmit coil comprising more than one antenna unit, said method comprising supplying stimulus signals to said antenna units via respective connecting cables, connecting said method comprising supplying wherein a capacitor in series before each of the cables, selecting a value of each capacitor so that the capacitor just compensates a signal phase shift caused by the connecting cable to zero, and connecting respective decoupling circuits between each antenna unit and before each capacitor for decoupling said antenna units.

2. A method as claimed in claim 1, comprising supplying said stimulus signals as orthogonal stimulus signals.

3. A method as claimed in claim 2 comprising using decoupling capacitors as decoupling members in said decoupling circuits, connecting opposite ends of said decoupling capacitors between the antenna units having the orthogonal signals supplied as inputs thereto, and disposing the connected ends before the associated capacitor for the connecting cables.

4. A method as claimed in claim 2, comprising dividing orthogonal stimulus signals from a power divider, and supplying each orthogonal stimulus signal with said capacitor directly and through an inverter, to respectively input the orthogonal stimulus signals to the antenna units.

5. A method as claimed in claim 4 comprising using decoupling capacitors as decoupling members in said decoupling circuits, connecting opposite ends of said decoupling capacitors between the antenna units having the orthogonal signals supplied as inputs thereto, and disposing the connecting ends of the decoupling capacitor between the capacitor connected in series and the inverter.

6. A method as claimed in claim 5 comprising disposing the opposite ends of the coupling capacitor before the inverter for combination with the decoupling capacitor, and connecting the opposite ends of the combined decoupling capacitor before the inverter.
